(19) United States
(12) Patent Application Publication
(10) Pub. No.: US 2025/0100090 A1
(43) Pub. Date: Mar. 27, 2025

(54) METHOD AND DEVICE FOR JOINING AND SHAPING SHEET MATERIALS

(71) Applicant: Baosteel Lasertechnik GmbH, Ravensburg (DE)

(72) Inventors: Gerhard ALBER, Berg (DE); Thomas MUFFLER, Ostrach (DE)

(21) Appl. No.: 18/729,225

(22) PCT Filed: Feb. 7, 2023
(86) PCT No.: PCT/EP2023/052897

§ 371 Date: Jul. 16, 2024

(30) Foreign Application Priority Data
Feb. 24, 2022 (DE) 102022104502.1
Apr. 1, 2022 (DE) 102022107873.6

(51) Int. Cl. B23K 37/04; B23K 26/323; B23K 26/38; B23K 37/047; B23K 101/18; B23K 103/18

(52) U.S. Cl. CPC B23K 37/0461; B23K 26/323; B23K 26/38; B23K 37/0408; B23K 37/047; B23K 2101/18; B23K 2103/18

(57) ABSTRACT

A method for joining and shaping flat materials. At least one first flat material and at least one second flat material are fed to a cutting and welding device in respective supply devices, each associated with one flat material.

### CROSS-REFERENCES TO RELATED APPLICATIONS

This Application is a Section 371 National Stage Application of International Application No. PCT/EP2023/052897, filed Feb. 7, 2023, and published as WO 2023/161004 A1 on Aug. 31, 2023, and claims priority to German Application No. 102022104502.1, filed Feb. 24, 2022 and German Application No. 102022107873.6, filed Apr. 1, 2022; the contents of these applications are hereby incorporated by reference in their entirety.

### BRIEF DESCRIPTION OF THE DRAWINGS

FIG. 1 shows a schematic overview of a device for the purpose of illustrating a method, in one example.

FIG. 2 shows an edge preparation process by means of a trimming cut, in one example.

FIG. 3 shows a parting cut for separating a first strip from a flat material, in one example.

FIG. 4 shows a process of joining and welding a first flat material to a second flat material, in one example.

FIG. 5 shows a release of an input-side holding device and a feed motion of an output-side holding device for the purpose of transporting a composite workpiece, in one example.

FIG. 6 shows a parting cut for separating a strip from a second flat material after the resetting of the output-side holding device, in one example.

FIG. 7 shows repetition of the steps for applying a strip of the third flat material and repetition with any desired combinations of flat materials to form a composite workpiece, in one example.

FIG. 8 shows an illustrative composite workpiece as a combination of strips of flat materials, in one example.

### DETAILED DESCRIPTION

The present disclosure relates to a method for joining and shaping flat materials, and to a device for carrying out the method in accordance with the features of the independent patent claims.

The method is used to produce profile elements which are composed of different flat materials with preferably different physical and technical properties and are fed to a shaping process after the joining and/or welding of the flat materials.

For the purposes of the present disclosure, a profile element should preferably be understood to mean a body in the form of a strand which, in its longitudinal direction, has a contour that is open at its periphery, at least in part.

In this context, the embodiment in which the flat materials are stored in supply devices, in particular a kind of supply tray, and these supply devices simultaneously perform the function of a flat material store, is particularly advantageous. This use, which is previously unknown from the prior art, in which flat materials are taken from the supply device, only partially cut off, and the residual pieces are fed back into the supply device for a subsequent repeated removal step, allows a continuous flat material mix of different starting materials which are combined in a freely selectable sequence, with stepwise removal and joining, to form a hybrid component.

Special embodiments of components consisting of different flat materials, e.g. profiles with technical and physical properties of the flat materials that vary at the periphery, can thereby be produced in a particularly efficient manner.

A technical object of the present disclosure is to reduce energy and emissions, in particular by efficient production, and to save resources in the case of construction profiles, both during their production and during their use, as well as overall to simplify the production of components of this kind.

The technical object is achieved by an item and a method having the technical features described herein.

For the purposes of the present disclosure, a composite workpiece should be understood to mean a workpiece which is composed of at least one first flat material joined to a second flat material.

For the purposes of the present disclosure, the number X should furthermore be understood to mean an arbitrary number.

Furthermore, for the purposes of the present disclosure, a first holding device should be understood to mean an input-side holding device, and a second holding device should be understood to mean an output-side holding device. Input-side and output-side should be understood in the sense that flat materials are fed in on the input side, and the processed flat materials are discharged on the output side.

According to one aspect, a technical object of the present disclosure is achieved by a method for joining and shaping flat materials, wherein at least one first flat material and at least one second flat material are fed to a cutting and welding device in respective supply devices, each associated with one flat material, comprising the method steps of:
a) supplying the first flat material from a first supply device;
b) placing and holding the first flat material on an input-side holding device;
c) aligning the first flat material at a joining edge of a starting workpiece, wherein the starting workpiece is held on an output-side holding device;
d) connecting the first flat material to the starting workpiece at the joining edge by means of a welding operation to give a composite workpiece;
e) transporting the composite workpiece in the direction of a delivery table by a first transport step distance;
f) separating a residual piece of the first flat material from the composite workpiece at a separating edge;
g) removing, in particular withdrawing, the residual piece of the first flat material from the input-side holding device;
h) supplying a second flat material from a second supply device;
i) placing and holding the second flat material on an input-side holding device;
j) aligning the second flat material at the separating edge on the composite workpiece, wherein the composite workpiece is held on an output-side holding device;
k) connecting the second flat material to the composite workpiece at the separating edge by means of a welding operation;
m) repeatedly feeding the first flat material or the second flat material or additional flat materials from respective supply devices.

The technical advantage is thereby achieved, for example, that the use of different flat materials allows the production of a customized composite workpiece which has individual requirements in terms of weight or stability. This can be produced with a plurality of weld seams in just one process cycle. This makes possible logistical advantages, for example, since the otherwise necessary additional process cycles of a conventional welding machine can be omitted. Moreover, even very narrow flat material widths of about 10 mm can be processed into a composite workpiece, thereby enabling fully optimized production of the composite workpiece in terms of cost, functional and weight optimization. Moreover, advantages are obtained in respect of environmental protection since not only can savings be made in terms of energy and thus emissions during production of the composite workpieces but also the composite workpieces can be configured and used specifically for energy and weight saving. Moreover, the production of unnecessary scrap during production can advantageously be avoided since method steps for removing material segments to reduce weight can be omitted.

Moreover, the technical advantage is thereby achieved, for example, that, during the further progress of the method, one of the flat materials can be quickly supplied and used.

In another technically advantageous embodiment of the method, a method step al) preceding method step a) is provided:
a1) carrying out an initial cut for edge preparation, wherein the first input material is trimmed, and a first strip of the input material is cut off as waste.

The technical advantage is thereby achieved, for example, that a defined edge that is provided with a shape appropriate to requirements can be produced.

In another technically advantageous embodiment of the method, a method step bi) following method step b) or i) is provided:
bi) preparing, in particular trimming, an edge, wherein preparation preferably takes place in the held state.

The technical advantage is thereby achieved, for example, that the flat material can be trimmed precisely and that the risk of distortion or slipping is minimized in order to be able to allow necessary tolerances.

In another technically advantageous embodiment of the method, it is envisaged that method step e) is carried out by means of the following method steps:
e1) releasing the input-side holding device;
e2) moving the composite workpiece, which is held on the output-side holding device, by the first transport step distance by means of the output-side holding device;
e3) applying the input-side holding device;
e4) releasing the output-side holding device;
e5) resetting the output-side holding device;
e6) holding the composite workpiece by means of the output-side holding device.

The technical advantage is thereby achieved, for example, that an advance of the composite workpiece which minimizes, and in the optimum case avoids, possible slipping is thereby made possible, for example, and it is thereby possible to increase the precision and accuracy of the joining of the flat materials to one another. For example, the distorting forces that occur on account of welding can be minimized by virtue of the fact that the composite workpiece can always be in a held state.

In another technically advantageous embodiment of the method, it is envisaged that the composite workpiece is held by means of the output-side holding device, in particular at the location of the last seam or joining edge formed. The technical advantage is thereby achieved, for example, that the stresses and distorting forces which occur specifically in the region of the joining edge to be welded have a reduced influence on the alignment and thus the quality of a subsequent welding operation.

In another technically advantageous embodiment of the method, a method step 1) following method step k) is provided:
1) repeating the preceding method steps with a number X of different flat materials.

The technical advantage is thereby achieved, for example, that any desired dimensions of the composite workpiece are made possible, at least in one dimension, and the composite workpiece can thus be produced in a customized fashion.

In another technically advantageous embodiment of the method, a method step g1) following method step g) is provided:
g1) storing the first flat material in a first supply device.

The technical advantage is thereby achieved, for example, that the first flat material can be reused in the subsequent course of the method and is quickly available. The additional flat materials can also be made available in this way, and this can make possible space-saving and rapid production. In addition, the cutting edge of the preceding cutting operation is already at the quality standard of a trimmed edge, and therefore an additional trimming cut and the associated loss of material is avoided.

In another technically advantageous embodiment of the method, it is envisaged that the process of separation in method step f) takes place in a straight line or following a contour, wherein, in particular, the process of separation in method step f) takes place at an angle to the surface normal of the flat material.

The technical advantage is thereby achieved, for example, that the edge to be welded can be shaped in any desired manner and on an individual basis and, in addition, the exploitation of advantages such as those of a welding operation by means of a V cut can be enabled.

In another technically advantageous embodiment of the method, it is envisaged that a concluding method step comprises a shaping process on the joined flat materials.

The technical advantage is thereby achieved, for example, that the initially planar composite workpiece consisting of the joined flat materials can be shaped into a three-dimensional workpiece which offers additional properties and further possible uses. For example, a composite workpiece shaped to form a beam can be used in the construction of vehicles to reduce weight while maintaining stability and can thus be used to make energy savings and reduce emissions.

Another embodiment of the method which employs a shaping process envisages that the shaping process comprises edging with an edging angle, in particular between 45° and 135°, preferably about 90°, wherein, in particular, a profile body that is open in its longitudinal direction is formed by means of the method.

Using the shaping operation for edging provides a simpler way of enabling an angled profile body, in particular a profile body which is open in a V shape or a U shape, which combines the advantages of the technical properties of the composite workpiece consisting of different joined flat materials to be produced.

According to another aspect, a technical object of the present disclosure is achieved by a device for carrying out a method for joining and shaping flat materials, comprising at least two supply devices, at least one first and at least one second holding device, at least one cutting and welding device, and at least one delivery table, wherein the supply devices are designed to be movable relative to the delivery table or relative to the second holding device.

The technical advantage is thereby achieved, for example, that the flat materials can be fed into the process rapidly and in any desired manner and thus that time advantages and cost advantages can be produced. For example, no additional space for storage of the flat materials is required on the device itself, and the entire production process can be carried out on just a single production line, for example.

In another technically advantageous embodiment of the device, it is envisaged that the supply devices are designed to be planar, in particular in the form of trays, and with a feed motion matched to the respective flat material, wherein, in particular, the feed motion has freely programmable axes.

The technical advantage is thereby achieved, for example, that the individual flat materials can be placed against one another in any orientation in a plane for the joining process, or that their orientation can be appropriately changed in any desired manner and thus that additional possibilities for customized production are obtained.

In another technically advantageous embodiment of the device, it is envisaged that each supply device comprises a respectively associated first holding device, and the second holding device is associated with the delivery table. The technical advantage is thereby achieved, for example, that the space required by the device is minimized, and a compact and space-saving production process is made possible.

In another technically advantageous embodiment of the device, it is envisaged that the supply devices are arranged vertically with respect to one another. The technical advantage is thereby achieved, for example, that the space required by the device in a plane is minimized, and a compact and space-saving production process is made possible.

In another technically advantageous embodiment of the device, it is envisaged that the holding devices comprise magnetic holding technology, or vacuum holding technology, or gripping yoke technology, wherein, in particular, the holding devices are designed for holding the flat materials on one side or on both sides.

The technical advantage is thereby achieved, for example, that any desired flat materials, likewise with any desired coating, can be processed, and the holding of these flat materials can be optimized.

In another technically advantageous embodiment of the device, it is envisaged that each supply device has clamping devices, in particular manipulators, for aligning or retaining the flat materials, wherein the clamping devices have, in particular, freely programmable movement axes.

The technical advantage is thereby achieved, for example, that the flat materials can be moved and joined to one another three-dimensionally in space, further improving the flexibility of customized production.

In another technically advantageous embodiment of the device, it is envisaged that the cutting and welding device comprises at least one laser head, wherein the at least one laser head is designed for welding the flat materials, and/or for cutting the flat materials, and/or for weld seam preparation, in particular for carrying out an ablation step at the edge of the flat materials.

The technical advantage is thereby achieved, for example, that additional devices for laser-supported machining of the flat materials on the device can be avoided and space-saving and compact production can thereby be enabled. Moreover, a time and energy saving in production is thereby made possible since it is possible to dispense with additional laser or cutting devices.

In another technically advantageous embodiment of the device, it is envisaged that the cutting and welding device is designed as a laser portal, in particular as a 2D laser portal. The technical advantage is thereby achieved, for example, that an improved cycle time in production can be made possible on just one production line.

In another technically advantageous embodiment of the device, it is envisaged that the laser head is designed as a remote laser head or as a near field laser head. The technical advantage is thereby achieved, for example, that flexibility in the production process can be increased, and more complex structures can be machined and produced.

In another technically advantageous embodiment of the device, it is envisaged that the device comprises a conveyor for removing waste from the device, wherein the conveyor comprises, in particular, a collecting hopper, and preferably comprises a suction extraction system. The technical advantage is thereby achieved, for example, that the device can additionally be used in a compact and space-saving manner and that cut-off residues do not hinder the progress of production.

In another technically advantageous embodiment of the device, it is envisaged that the device comprises a transfer device between the delivery table and a shaping device. The technical advantage is thereby achieved, for example, that rapid transport between these two positions is made possible, and this can have a positive effect on the time of production.

In another technically advantageous embodiment of the device, it is envisaged that the flat materials are supplied from a feedstock store, in particular by means of flat material coils or by means of flat material plates. The technical advantage is thereby achieved, for example, that the device can be operated continuously and that downtimes, e.g. for reloading, can be avoided since the feedstock store can be loaded independently.

Exemplary embodiments of the present disclosure are illustrated in the drawings and are described below in greater detail.

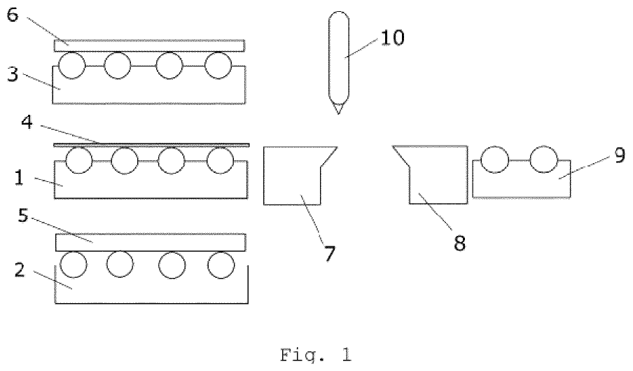

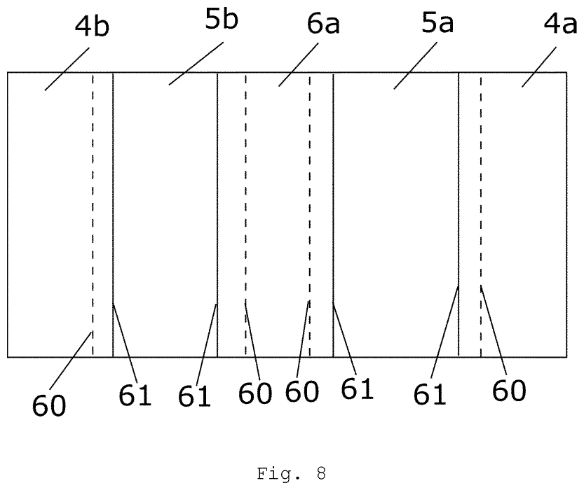

Viewing FIGS. 1 to 7 together shows an illustrative embodiment of the method and a schematic illustration of the device up to the production of the composite workpiece shown in FIG. 8.

The supply devices 1, 2, 3 supply a flat material 4, 5, 6 respectively associated therewith and resting thereon, which can be held on an input-side holding device 7 and an output-side holding device 8, while it is being machined with a cutting and welding device designed as a laser head 10, in order to transport it in the direction of the delivery table 9. This is illustrated in FIG. 1 by flat materials 4, 5, 6 which, by way of example, differ in thickness. It is advantageously possible, for example, to use flat materials with very different geometrical or physical properties.

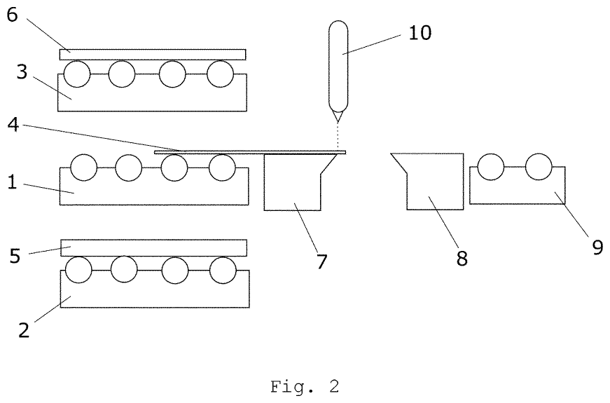

FIG. 2 shows that the first flat material 4 has been moved in the direction of the input-side holding device 7 and partially beyond this in the direction of the output-side holding device 8 by means of the supply device 1 and then undergoes a trimming cut by means of the laser head 10 for the purpose of edge preparation. The strip of flat material 4 (not denoted specifically) which has thereby been cut off can then be removed as waste from the device, although this is not illustrated specifically.

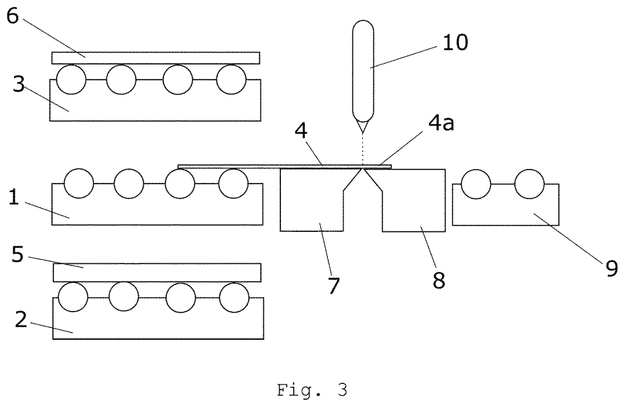

Following the trimming cut, the first flat material 4, as illustrated in FIG. 3, is once again moved beyond the holding device 7, and the output-side holding device 8 then additionally holds the first flat material 4. It is thereby advantageously possible to enable the parting cut now carried out by means of the laser head 10 in order to produce a first strip of first flat material 4a to be carried out in a precise manner and without distorting the first flat material 4.

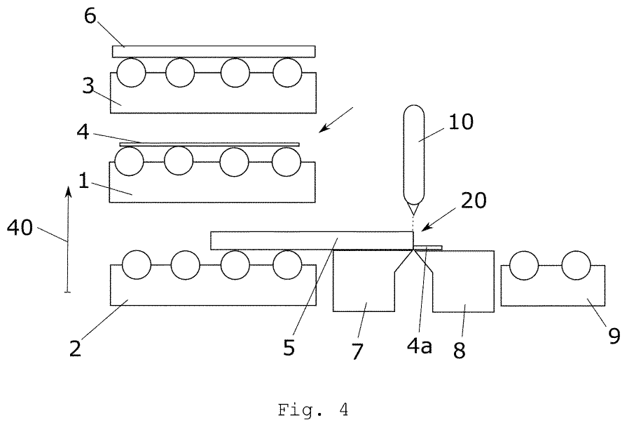

Once the first strip 4a has been cut off, the now shortened first flat material 4c is, as illustrated in FIG. 4, pulled back again and stored within the supply device for possible later use. The first strip of first flat material 4a continues to be held on the output-side holding device as a starting workpiece. The supply devices then undergo a horizontal offset 40 in order to make available a second flat material 5. During its first use, this flat material 5 too is initially trimmed. Like the first flat material 4, this is moved in the direction of the output-side holding device and beyond the input-side holding device and placed against the strip of first flat material 4a, which is still being held in the output-side holding device 8. As flat material 5 is placed against flat material 4a, trimming ceases.

By means of a welding operation that is now carried out by the laser, the second flat material 5 is joined to the strip of first flat material 4a to form a composite workpiece 20, while both flat materials are at all times firmly held on the holding devices 7, 8. It is thus advantageously possible to optimize the quality of the welding operations if, at each point in time after separation, at least the first strip of first flat material 4a, or the composite workpiece 20, is at least in part firmly held until the composite workpiece 20 has been fully produced.

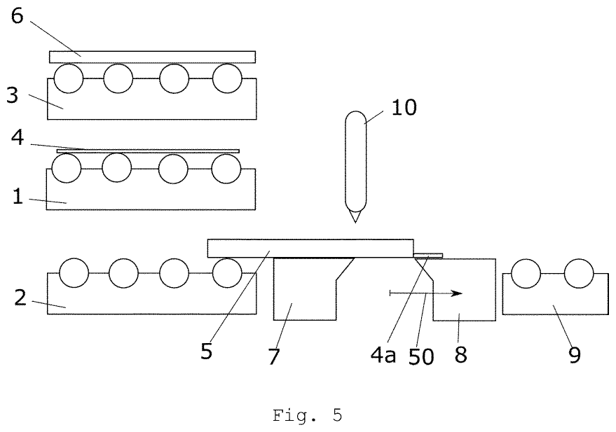

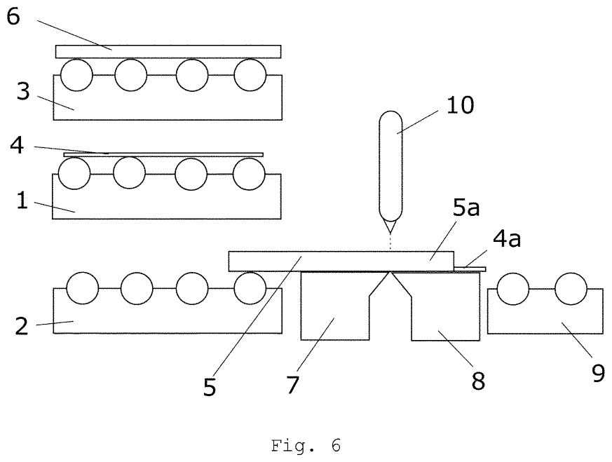

FIG. 5 illustrates how the second flat material 5 joined to the first strip of first flat material 4a, having been released from the input-side holding device 7, is pulled and moved in the direction of the delivery table 9 by means of the output-side holding device. In this way, the composite workpiece 20, which at this point in time is formed from the first strip of first flat material 4a and the second flat material 5, is moved by a transport distance 50 by means of a feed motion of the output-side holding device to such an extent that a further parting cut, illustrated in FIG. 6, by means of the laser head 10 can be made possible.

FIG. 6 illustrates that, owing to the feed motion of the output-side holding device 8, the composite workpiece 20 is initially once again held by the input-side holding device 7, the output-side holding device 8 has been released, and this has once again been moved back to the input-side holding device 7. Here, the output-side holding device 8 once again holds the composite workpiece 20, and a precise parting cut by the laser head on the second flat material 5 can be made possible. This produces a second strip of second flat material 5a, which is now firmly welded to the first strip of first flat material 4a and jointly forms the composite workpiece 20 held on the output-side holding device.

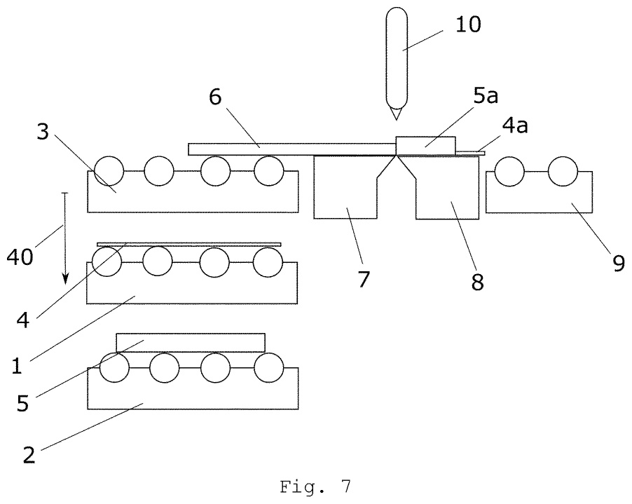

FIG. 7 illustrates how, once again, the supply devices 1, 2, 3 are moved by an offset 40 in order now to make available a third flat material 6. In a similar manner to the previous sequence, this is joined and welded to the edge of the second strip of second flat material 5a by means of the laser head.

By repeating the method steps, it is possible quickly and economically to produce a composite workpiece 20 that can contribute in a customized and individual manner to the reduction of emissions during its production or during its use. With a combination of flat materials that differ in their physical or geometrical properties or surface coatings, the composite workpiece can be matched in an optimum manner to desired requirements and, by means of a shaping process, can, for example, form beams or components which have customized properties in terms of weight or stability.

FIG. 8 shows an illustrative composite workpiece as a combination of strips of flat materials. The flat materials 4, 5, 6 were processed by means of the device described and in accordance with the method described to give respective strips 4a, 4b, 5a, 5b, 6a which, in turn, can be joined to one another by means of weld seams 61. The composite workpiece 20 is then shaped at the shaping edges 60. In this process, it is advantageously possible, for example, to produce a customized beam which, by virtue of its flat material mix, can be matched in a flexible manner to desired requirements. This can have an advantageous effect in reducing environmentally damaging emissions since less scrap and waste is produced during production, production can be carried out quickly and in an energy-saving manner, and the shaped composite workpiece 20 can be used to reduce weight, e.g. in the construction of vehicles.

Although the present invention has been described with reference to preferred embodiments, workers skilled in the art will recognize that changes may be made in form and detail without departing from the spirit and scope of the invention.

### LIST OF REFERENCE SIGNS

1 first supply device
2 second supply device
3 third supply device
4 first flat material
4a first strip of first flat material
4b fifth strip of first flat material
4c residual piece of first flat material, stored in a withdrawn location and shortened
5 second flat material
5a second strip of second flat material
5b fourth strip of second flat material
6 third flat material
6a third strip of third flat material
7 input-side holding device
8 output-side holding device
9 delivery table
10 laser head
20 composite workpiece
40 offset of the supply devices
50 transport step distance/feed motion of the output-side holding device
60 shaping edges
61 weld seams

1. A method for joining and shaping flat materials,
wherein at least one first flat material and at least one second flat material are fed to a cutting and welding device in respective supply devices, each associated with one flat material, comprising the method steps of:
a) supplying the first flat material from a first supply device;
b) placing and holding the first flat material on an input-side holding device;
c) aligning the first flat material at a joining edge of a starting workpiece, wherein the starting workpiece is held on an output-side holding device;
d) connecting the first flat material to the starting workpiece at the joining edge by a welding operation to give a composite workpiece;
e) transporting the composite workpiece in a direction of a delivery table by a first transport step distance;
f) separating a residual piece of the first flat material from the composite workpiece at a separating edge;
g) removing the residual piece of the first flat material from the input-side holding device;
h) supplying a second flat material from a second supply device;
i) placing and holding the second flat material on an input-side holding device;
j) aligning the second flat material at the separating edge on the composite workpiece, wherein the composite workpiece is held on an output-side holding device;
k) connecting the second flat material to the composite workpiece at the separating edge by a welding operation;
m) repeatedly feeding the first flat material or the second flat material or additional flat materials from respective supply devices.

2. The method as claimed in claim 1, comprising a method step that precedes method step a):
a1) carrying out an initial cut for edge preparation, wherein the first flat material is trimmed, and a first strip of the first flat material is cut off as waste.

3. The method as claimed in claim 1, comprising a method step that follows method step b) or i):
bi) preparing an edge.

4. The method as claimed in claim 1, wherein method step e) is carried out by the following method steps:
e1) releasing the input-side holding device;
e2) moving the composite workpiece, which is held on the output-side holding device, by the first transport step distance by the output-side holding device;
e3) applying the input-side holding device;
e4) releasing the output-side holding device;
e5) resetting the output-side holding device;
e6) holding the composite workpiece by the output-side holding device.

5. The method as claimed in claim 1, wherein the composite workpiece is held by the output-side holding device.

6. The method as claimed in claim 1, comprising a method step that follows method step k);
1) repeating the preceding method steps with a number X of different flat materials.

7. The method as claimed in claim 1, comprising a method step that follows method step g):
g1) storing the first flat material the first supply device.

8. The method as claimed in claim 1, wherein the separation in method step f) takes place in a straight line or following a contour.

9. The method as claimed in claim 1, wherein a concluding method step comprises a shaping process on the joined flat materials.

10. The method as claimed in claim 9, wherein the shaping process comprises edging with an edging angle, wherein, a profile body that is open in its longitudinal direction is formed.

11. A device for joining and shaping flat materials, the device comprising:
a first supply device,
a second supply device,
at least one input-side holding device,
at least one output-side holding device,
at least one cutting and welding device, and
at least one delivery table,
wherein the first supply device and the second supply device are configured to be movable relative to the at least one delivery table or relative to the at least one output-side second-holding device, wherein the device is configured to:
supply a first flat material from the first supply device;
place and hold the first flat material on the at least one input-side holding device;
align the first flat material at a joining edge of a starting workpiece, wherein the starting workpiece is held on the at least one output-side holding device; connect the first flat material to the starting workpiece at the joining edge by a welding operation to give a composite workpiece;
transport the composite workpiece in a direction of the at least one delivery table by a first transport step distance;
separate a residual piece of the first flat material from the composite workpiece at a separating edge;
withdraw the residual piece of the first flat material from the at least one input-side holding device;
supply a second flat material from the second supply device;
place and holding the second flat material on the at least one input-side holding device;
align the second flat material at the separating edge on the composite workpiece, wherein the composite workpiece is held on the at least one output-side holding device;
connect the second flat material to the composite workpiece at the separating edge by a welding operation; and
repeatedly feed the first flat material or the second flat material or additional flat materials from respective supply devices.

12. The device as claimed in claim 11, wherein the first supply device and the second supply device are designed to be planar, and with a feed motion matched to the respective flat material.

13. The device as claimed in claim 11, wherein each supply device, of the first supply device and the second supply device, comprises a respectively associated input-side holding device, and the at least one output-side holding device is associated with the at least one delivery table.

14. The device as claimed in claim 11, wherein the first supply device and the second supply device are arranged vertically with respect to one another.

15. The device as claimed in claim 11, wherein the at least one input-side holding device and the at least one output-side holding device
comprise magnetic holding technology, or vacuum holding technology, or gripping yoke technology.

16. The device as claimed in claim 11 wherein each supply device has clamping devices.

17. The device as claimed in claim 11, wherein the cutting and welding device comprises at least one laser head, wherein the at least one laser head is designed for welding the flat materials, and/or for cutting the flat materials, and/or for weld seam preparation.

18. The device as claimed in claim 5, wherein the composite workpiece is held by the output-side holding device at a location of a last seam or joining edge.

19. The device as claimed in claim 8, wherein the process of separation in method step f) takes place at an angle to a surface normal of the flat material.

20. The device as claimed in claim 16, wherein the clamping devices comprise manipulators configured to align or retain the flat materials.

21. The device as claimed in claim 20, wherein the clamping devices have freely programmable movement axes.

22. The device as claimed in claim 11, wherein the flat materials are supplied from a feedstock store.
